(19) United States
(12) Patent Application Publication
(10) Pub. No.: US 2008/0257166 A1
(43) Pub. Date: Oct. 23, 2008

(54) MODULAR COOKING APPARATUS

(76) Inventor: ZHENG PENG, Ypsilanti, MI (US)

Correspondence Address: ZHAOXIA XU, 4694 SYCAMORE DR., YPSILANTI, MI, 48197, US

(21) Appl. No.: 11/738,480

(22) Filed: Apr. 21, 2007

(51) Int. Cl. A47J 27/02

(52) U.S. Cl. 99/337; 99/443 R

(57) ABSTRACT

A modular cooking apparatus (100). Apparatus (100) comprises a container (102) having an open top and a sidewall for holding and cooking food, a lid (104) for closing the open top of container (102), a heating tube (116) fixedly installed on the bottom of container (102) for heating food, a universal base (112) disposed underneath container (102) for supporting container (102), an adapting member (110) fixedly installed on the bottom of container (102) for adapting container (102) to removably stand in position on universal base (112), and a thermostat (122) installed on universal base (112) and adapted to detect and control the temperature of the bottom of container (102).

### TECHNICAL FIELD AND INDUSTRIAL APPLICABILITY OF THE INVENTION

This invention generally relates to cooking apparatuses. More specifically, this invention relates to a modular cooking apparatus that includes an interchangeable serve-safe cooking pan.

### BACKGROUND OF THE INVENTION

Traditional cooking appliances have a full housing to house a cooking vessel sitting on a heater that is installed inside the housing. Examples of such appliances include deep fryers, hot pots, slow cookers, rice cookers, etc. Consumers have to buy different cooking appliances for various applications. The problem is that consumers have limited kitchen space for these appliances in their home. The high cost associated with buying these appliances is another issue. Therefore, there is a need for kitchen appliance consolidation, such that consumers do not have to buy many appliances for their cooking needs. Various appliances can share one universal or common base and consumers simply buy different cooking vessels for specific uses. Base sharing of cooking appliances will save kitchen space and buying cost for consumers. Varying the depth or the upper diameter of a cooking pan may result in a new appliance for a different use. Such accessories include slow cooking pans, hot pots, fondue pots, kitchen kettles, deep-frying pans, skillet pans, woks, grill pans, etc. While different pans are used, the universal base remains the same.

Consumers also desire a cooking pan that is serve-safe, that's, a cooking pan that can directly sit on a dinning table without the risk of overheating the same. Serve-safe cooking pan wilt save consumers' effort in unloading food after cooking and reduce the use of tableware for serving food, resulting in less tableware for cleaning after meals.

Therefore, it remains desirable to provide a modular cooking apparatus that is innovative in design, such that it has a modular cooking pan that can fit onto a universal or common base and that is serve-safe, that's, a cooking pan that can be used as tableware for serving food after being used for cooking.

### BRIEF SUMMARY OF THE INVENTION

Accordingly, the present invention is a modular cooking apparatus. This modular cooking apparatus comprises a container having an open top and a sidewall for holding and cooking food, a lid for closing the open top of the container, a heating tube fixedly installed on the bottom of the container for heating food, a universal base disposed underneath the container for supporting the container, an adapting member fixedly engaged with the tower portion of the container and extended downward to a predetermined distance for adapting the container to removably stand on the universal base, and a thermostat installed on the universal base and adapted to detect and control the temperature of the bottom of the container. As the container is installed in position on the universal base, the heating tube is operationally connected with an electrical port on the universal base for supplying electrical power to the heating tube.

Accordingly, the followings are some of the objects, features, and advantages of the present invention.

It is an object of the present invention to provide a modular cooking apparatus that allows a use to change the cooking pan for various cooking applications.

It is another object of the present invention to provide a modular cooking apparatus that has a serve-safe cooking pan.

It is a feature of the present invention that this modular cooking apparatus includes an adapting member for supporting a container. The upper end of the adapting member is fixedly engaged with the periphery of the bottom portion of the container and the lower end is extended downward to a predetermined distance for adapting the container to stand on a universal base for use of cooking or on a horizontal surface for use of serving food.

It is another feature of the present invention that the container includes an upper portion made from a non-metal material, preferably, transparent, such that a user can consume food directly from the container, which acts as a serving bowl, and a lower portion made from a metal material of high thermal conductivity, such that a heater can be attached thereon for heating food.

It is a further more feature of the present invention that the heating tube is fixedly installed on the bottom of the container. By directly installing the heating tube on the bottom of the container heating efficiency is significantly enhanced and the cost for manufacturing is significantly reduced.

It is an advantage of the present invention that various cooking pans share one common base, such that consumers do not have to buy many appliances for their cooking needs. Consumers buy only one universal base and multiple cooking pan accessories for various applications.

it is another advantage of the present invention that a user can use the cooking pan accessory as a pan for cooking food, as tableware for serving food, or even as a serving bowl for direct food consumption.

Further more features and advantages of the present invention will be readily appreciated, as the same becomes better understood after reading the subsequent description when considered in connection with the non-limiting accompanying drawings.

### BRIEF DESCRIPTION OF THE DRAWINGS

FIG. 1 illustrates a cross-sectional view of an embodiment of the present invention, a modular cooking apparatus 100.

FIG. 2 illustrates a bottom view of container 102.

FIG. 3 illustrates a top view of universal base 112.

FIG. 4 illustrates another cross-sectional view of modular cooking apparatus 100.

### DETAILED DESCRIPTION OF THE INVENTION

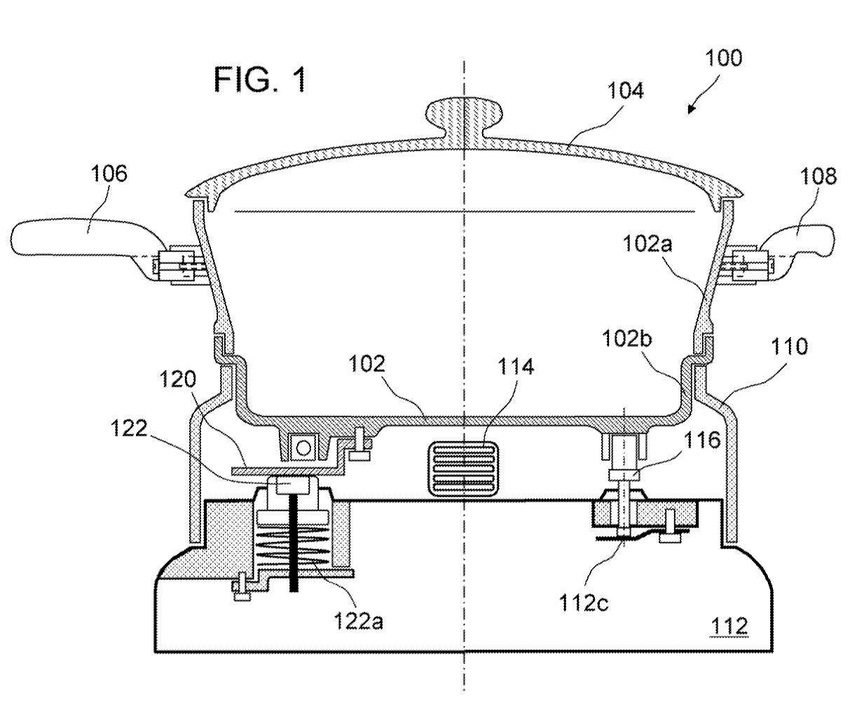

Reference is made to FIG. 1, which illustrates a cross-sectional view of an embodiment of the present invention, a modular cooking apparatus 100.

A container 102, having an open top and a sidewall, is provided for holding and cooking food. The sidewall of container 102 is slightly tapered with a larger diameter on the top and a smaller diameter on the bottom. Container 102 includes an upper portion 102a, which is made from a non-metal material, and a lower portion 102b, which is made from a metal material of high thermal conductivity. Upper portion 102a and lower portion 102b are fixedly and sealingly engaged with each other using a super glue of high heat resistance. Other manufacturing processes are readily applicable for this application, as known to those skilled in the art. The separation line or interface is disposed at a predetermined distance away from a heating element on the bottom of container 102, such that the separation interface and upper portion 102a are not overheated with heat transferred from lower portion 102b. Upper portion 102a is preferably made from a transparent material, such that a use can see through for observation of cooking processes. Lower portion 102b is preferably coated with a non-stick material for ease of cleaning after use.

A lid 104 is provided for closing the open top of container 102. Lid 104 is, preferably, made from a transparent material.

A grasp handle 106 and a lift handle 108 are fixedly installed on the upper portion of the sidewall of container 102 for use of handling container 102. Handle 106 can be either generally straight or curved, like a handle for a pitcher, based on specific design or application requirements, as known to those skilled in the art.

An adapting member 110 having a generally tapered hollow cylindrical configuration, is provided for supporting container 102. The upper end of member 110 is fixedly engaged with the periphery of the bottom portion of container 102 and the lower end is extended downward to a predetermined distance, such that container 102 is adapted to stand on a universal base 112 for cooking purposes, or on a horizontal countertop or a dinning table for serving food. Member 110 is, preferably, made from a non-metal material of low thermal conductivity, such that container 102 can directly stand on a dinning table without the risk of overheating the same. Since the upper end of member 110 is engaged with the bottom portion of container 102, the material for member 110 should be of high heat resistance. However, other materials are readily applicable, such as metal materials, as known to those skilled in the art and suggested by this invention disclosure. Member 110 is provided also for enclosing the space underneath the bottom of container 102 into a protected space for safety consideration. A window or slot, designated as 114, may be opened on member 110 for venting heated air to reduce the heating load of member 110 and the neighboring components.

An electrical heating tube 116, having a generally circular configuration, is provided for heating food disposed inside container 102. Heating tube 116 is fixedly installed on the outside surface of the bottom of container 102, inserted into a groove formed on the bottom, and disposed close to the periphery of the bottom with a predetermined distance. The two electrical terminals of heating tube 116 are extended downward to a predetermined distance and are adapted to removably engage with an electrical power supply, as container 102 is installed in position on base 112. There are significant advantages of installing heating tube 116 directly on the bottom of container 102. These advantages include saving a significant amount of material for building a full heater that has a thermal diffusion plate, resulting in space and cost saving, higher heat transfer efficiency, etc. Other heating mechanisms are readily applicable, such as induction heating, as known to those skilled in the art and suggested by this invention disclosure.

A thermo plate 120, made from a metal material of high thermal conductivity, is fixedly installed on the bottom of container 102, at a location substantially close to heating tube 116, for removably engaging a thermostat 122. Thermostat 122 is installed on base 112 and removably engaged with thermo plate 120 for detecting the temperature of the bottom of container 102, as container 102 is installed in position on base 112. Such temperature is used to control the electrical power to heating tube 116. The upper end of thermostat 122 protrudes upward above the upper surface of base 112 with pre-loading, e.g., biased via a spring member 122a. Thermostat 122 can be a digital sensor, such as a NTC or PTC, or an adjustable thermostat, or simply a temperature switch, as known to those skilled in the art and suggested by this invention disclosure.

Container 102 is adapted to stand on base 112 to be used as a pan for cooking food. As container 102 is properly installed in position on base 112, thermostat 122 is engaged with thermo plate 120, or directly with the bottom of container 102, and the electrical terminals of heating tube 116 are connected with an electrical port 112c that is installed on base 112.

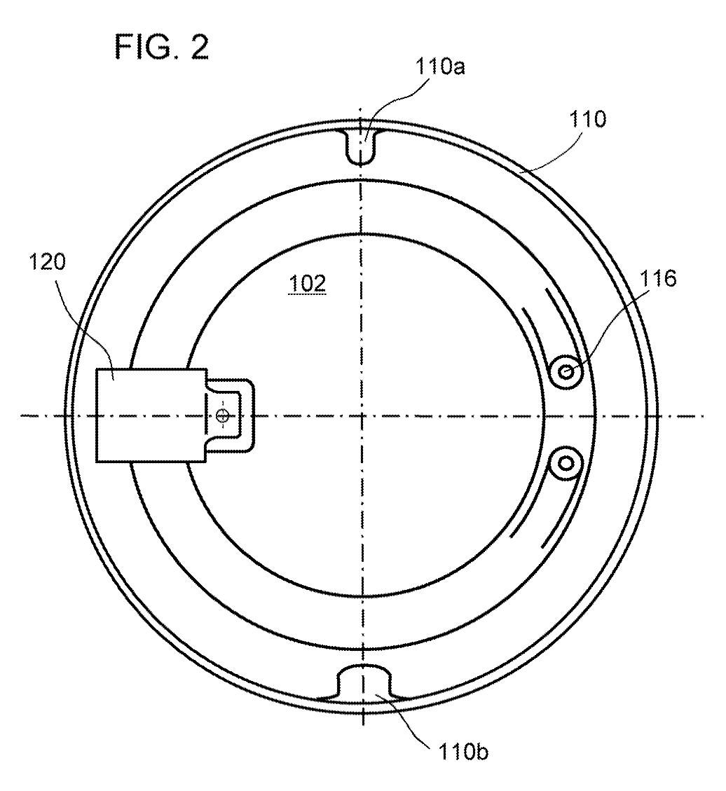

FIG. 2 illustrates a bottom view of container 102 to depict the general layout of various components disposed on the bottom. Two position guides, generally designated as 110a and 110b, protrude inward a predetermined distance from the inner surface of adapting member 110 for guiding container 102 in position on base 112 and for preventing container 102 from rotating with respect to base 112.

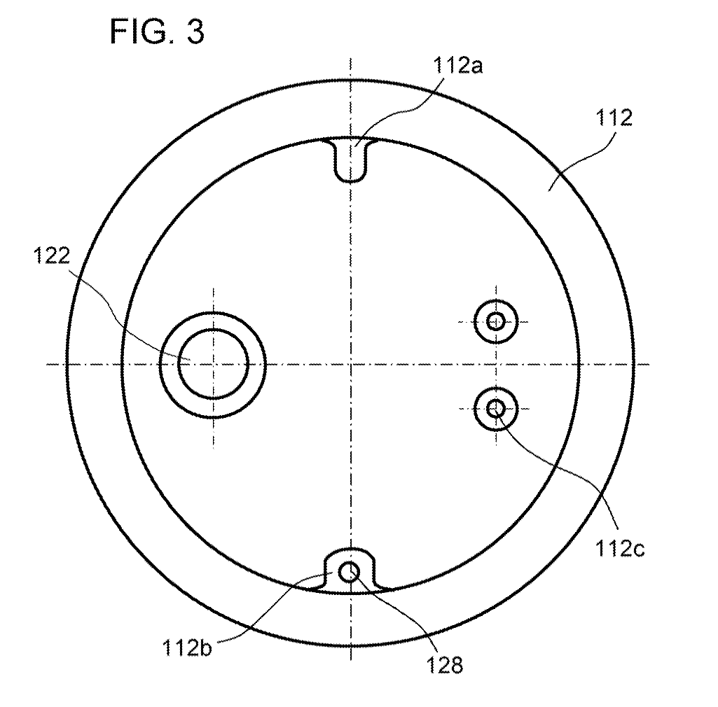

FIG. 3 illustrates a top view of base 112 to depict the general layout of various components disposed on the top. Two base guides generally designated as 112a and 112b, are provided for removably receiving position guides 110a and 110b, respectively. Electrical port 112c is disposed on top of base 112 for removably receiving the electrical terminals from heating tube 116, such that electrical power from base 1112 can be provided to heating tube 116, as container 102 is installed in position on base 112. An in-position detector 128 is installed on base 112 for detecting whether container 102 is properly installed or not.

Detector 128 is disposed at the bottom of base guide 112b. The upper end of detector 128 protrudes a predetermined distance above the bottom of guide 112b, such that when container 102 is installed in position on base 112, the tower end of position guide 110b would press with a force on detector 128 to confirm that container 102 is well positioned. Detector 128 is a switch device, which deactivates heating tube 116 if container 102 is not property installed on base 112.

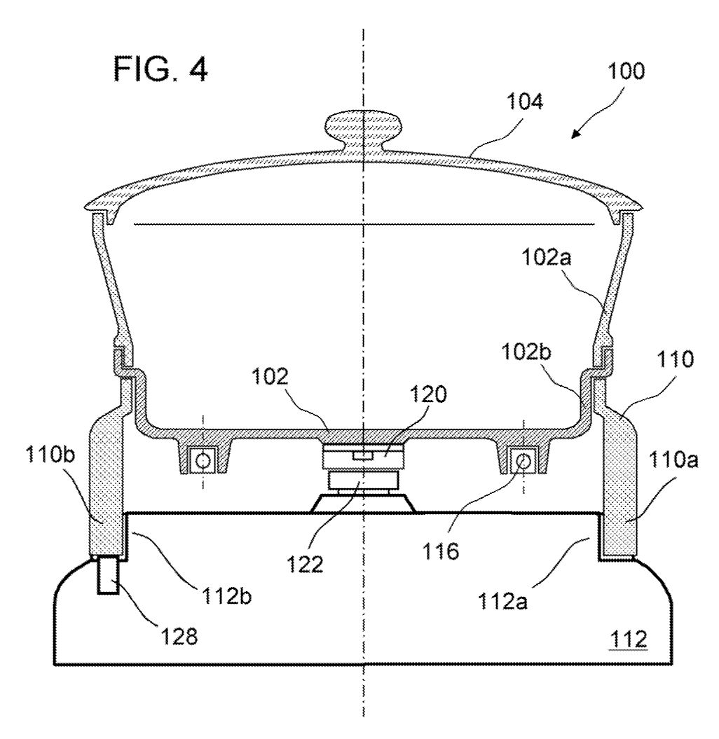

FIG. 4 illustrates another cross-sectional view of apparatus 100 to better describe how container 102 is installed on base 112. Position guides 111a and 110b are inserted into base guides 112a and 112b, respectively, such that container 102 is removably locked in position on base 112, limiting the rotation of container 102 with respect to base 112.

Container 102 can have various designs, varying the depth, or the upper diameter, or both, to be adapted for various applications, such as designed as slow cooking pans, fondue pots, hot pots, kitchen kettles, deep-frying pans, skillet pans, woks, grill pans, etc. While different pans are used, base 112 remains the same.

Accordingly, readers will see that this cooking apparatus of the present invention includes a modular cooking pan that can be adapted to stand on a universal base for cooking purposes and that can be used as a pan for cooking food, as tableware for serving food, or even as a serving bowl for direct food consumption by a user. The container is removable from the universal base, such that the cooking pan is convenient for cleaning after use and dishwasher safe. Many cooking pans of various applications share one common base, such that consumers do not have to buy many appliances for their cooking needs, and instead, they are able to buy various cooking pans, as accessories, which are much less expensive than full appliances.

The present invention has been described in an illustrative manner. It is to be understood that the terminology, which has been used, is intended to be in the nature of words of description rather than of limitation.

Although this invention has been described in its preferred forms and structures with a certain degree of particularity, these should not be construed as limiting the scope of the invention but as merely providing illustrations of some of the presently preferred embodiments of this invention.

Thus it is understood that the present disclosure of the preferred forms can be changed in the details of construction and in the combination and arrangement of parts without departing from the spirit and the scope of the invention as hereinafter claimed.

What is claimed is:

1. A modular cooking apparatus, said modular cooking apparatus comprising:
a container having an open top and a sidewall for holding and cooking food;
a lid for closing the open top of said container;
heating means for heating food disposed inside said container;
wherein said heating means is fixedly installed on the bottom of said container;
an adapting member fixedly engaged with said container for adapting said container to removably stand on a universal base; and
wherein said container is removable from said universal base for cleaning after use.

2. A modular cooking apparatus as defined in claim 1, wherein said container includes an upper portion and a lower portion, said upper portion is made from a non-metal material and said lower portion is made from a metal material of high thermal conductivity, said upper portion and said lower portion are fixedly and sealingiy engaged with each other at a separation interface that is substantially far away from said heating means, such that said upper portion is not overheated with heat transferred from said lower portion.

3. A modular cooking apparatus as defined in claim 1, wherein said adapting member includes an upper end and a lower end, the upper end is fixedly engaged with the periphery of the tower portion of said container, and the lower end is extended downward to a predetermined distance and is removably engaged with said universal base.

4. A modular cooking apparatus as defined in claim 1, wherein said adapting member includes at least one position guide for guiding said container in position on said universal base and for preventing said container from rotating with respect to said universal base.

5. A modular cooking apparatus as defined in claim 1, wherein said adapting member has a generally hollow cylindrical configuration, the upper end of said adapting member is routed over the lower portion of said container and is fixedly engaged thereof, and the lower end of said adapting member is routed over the upper portion of said universal base and is removably engaged thereof.

6. A modular cooking apparatus as defined in claim 1, wherein said heating means includes a heating tube of a generally circular configuration, said heating tube is fixedly installed inside a groove formed on the bottom of said container, and said heating tube is disposed close to the periphery of the bottom of said container with a predetermined distance.

7. A modular cooking apparatus as defined in claim 1, wherein said heating means includes a heating tube of a generally circular configuration said heating tube is welded on the bottom of said container, and said heating tube is disposed close to the periphery of the bottom of said container with a predetermined distance.

8. A modular cooking apparatus as defined in claim 1, wherein the electrical terminals of said heating means are adapted to be removably engaged with an electrical port disposed on said universal base for supplying electrical power to said heating means, as said container is installed in position on said universal base.

9. A modular cooking apparatus as defined in claim 1, said modular cooking apparatus further including a thermostat installed on said universal base for detecting and limiting the temperature of the bottom of said container, such that said heating means and the neighboring components are not overheated.

10. A modular cooking apparatus as defined in claim 9, wherein said thermostat is biased with a spring member, the upper end of said thermostat protrudes upward above the upper surface of said universal base, and when said container is disposed in position on said universal base said thermostat is adapted to be engaged with the bottom of said container.

11. A modular cooking apparatus as defined in claim 9, wherein said thermostat is biased with a spring member, a thermo plate is fixedly installed on the bottom of said container at a location substantially close to said heating means, the upper end of said thermostat protrudes upward above the upper surface of said universal base, and when said container is disposed in position on said universal base said thermostat is adapted to be engaged with said thermo plate.

12. A modular cooking apparatus, said modular cooking apparatus comprising:
a container having an open top and a sidewall for holding and cooking food;
a lid for closing up the open top of said container;
heating means for heating food disposed inside said container;
wherein said heating means includes a heating tube of a generally circular configuration, said heating tube is fixedly installed on the bottom of said container, and said heating tube is disposed close to the periphery of the bottom of said container with a predetermined distance;
a universal base disposed underneath said container for supporting said container;
a thermostat installed on said universal base for detecting and limiting the temperature of the bottom of said container, such that said heating tube and the neighboring components are not overheated;
an adapting member fixedly engaged with said container for adapting said container to removably stand on said universal base;
wherein the electrical terminals of said heating tube are removably engaged with an electrical port disposed on said universal base as said container is installed in position on said universal base;
wherein said thermostat is removably engaged with the bottom of said container or a thermo plate that is installed on the bottom of said container as said container is installed in position on said universal base;
wherein said container is removable from said universal base; and
whereby said container is convenient for cleaning after use and dishwasher safe.

13. A modular cooking apparatus as defined in claim 12, wherein said container includes an upper portion and a lower portion, said upper portion is made from a non-metal material and said lower portion is made from a metal material of high thermal conductivity, said upper portion and said lower portion are fixedly and sealingly engaged with each other at a separation interface that is substantially far away from said heating tube.

14. A modular cooking apparatus as defined in claim 13, wherein said upper portion of said container is made from a transparent material and whereby a user can see through for observing cooking processes.

15. A modular cooking apparatus as defined in claim 12, wherein said adapting member includes an upper end and a lower end, the upper end of said adapting member is fixedly engaged with the periphery of the lower portion of said container, and the lower end of said adapting member is extended downward to a predetermined distance and is removably engaged with the upper portion of said universal base.

16. A modular cooking apparatus as defined in claim 12, wherein said adapting member includes at least one position guide for guiding said container in position on said universal base and for preventing said container from rotating with respect to said universal base and said universal base includes at least one base guide for removably receiving said at least one position guide.

17. A modular cooking apparatus as defined in claim 12, wherein said adapting member has a generally hollow cylindrical configuration, the upper end of said adapting member is routed over the lower portion of said container and is fixedly engaged thereof, the lower end of said adapting member is routed over the upper portion of said universal base and is removably engaged thereof.

18. A modular cooking apparatus as defined in claim 12, wherein said adapting member is made from a non-metal material of high thermal resistance, such that said container is adapted for serving food without the risk of overheating a counter top or a dinning table, and whereby said container is serve-safe.

19. A modular cooking apparatus as defined in claim 12, wherein said adapting member includes a window for venting heated air, such that said adapting member is not overheated.

20. A modular cooking apparatus as defined in claim 12, wherein said universal base includes an in-position detector installed on said universal base for detecting whether said container is properly installed on said universal base or not and wherein if said container is not properly installed on said universal base said in-position detector shuts off electrical power to said heating tube.
